(19) United States
(12) Patent Application Publication
(10) Pub. No.: US 2013/0334867 A1
(43) Pub. Date: Dec. 19, 2013

(54) Axle System

(71) Applicants: Armin Christ, Bessenbach (DE); Olaf Drewes, Aschaffenburg (DE)

(72) Inventors: Armin Christ, Bessenbach (DE); Olaf Drewes, Aschaffenburg (DE)

(73) Assignee: SAF-HOLLAND GmbH, Bessenbach (DE)

(21) Appl. No.: 13/984,118

(22) PCT Filed: Feb. 21, 2012
(86) PCT No.: PCT/EP2012/052890

§ 371 Date: Aug. 23, 2013

(30) Foreign Application Priority Data
Mar. 1, 2011 (DE) 10 2011 004 897.9
Mar. 1, 2011 (DE) 20 2011 003 373.2

(51) Int. Cl. B60B 27/00; B60B 35/00

(52) U.S. Cl. CPC B60B 27/0057; B60B 35/00
USPC 301/6.1; 29/525.01

(57) ABSTRACT

An axle system including an external unit having a maximum extent D₁ transversely with respect to an axis of rotation, a brake drum element comprises a face part extending transversely with respect to the axis of rotation and has a cutout, and a drum casing that extends substantially parallel to the axis of rotation, the cutout of the face part having an extent transversely with respect to the axis of rotation of at least D₁, the extent of the drum casing transversely with respect to the axis of rotation is smaller than the internal dimension of an attachment unit which can be fixed to and at least partially surrounds the brake drum element, the external unit is arranged in the direction of the axis of rotation on a hub unit, and wherein the brake drum element can be moved over the external unit and fixed to the hub unit.

### BACKGROUND OF THE INVENTION

The present invention relates to an axle system, in particular for use in utility vehicles or commercial vehicles.

Axle systems which are known in the prior art comprise a brake drum unit which preferably is such that it can be mounted and dismounted from the outside. In case further attachment units are additionally arranged on the axle system from the outside, there is the problem that said attachment units firstly have to be dismounted in order to be able to subsequently mount or dismount the brake drum unit. In particular, in case sensitive attachment units are used, the dismounting of which causes considerably increased outlay, many of the advantages of a brake drum unit which is easily accessible from the outside are curtailed or even reversed to the opposite. Hitherto common combinations of materials did not allow for an improved design of the brake drum unit.

### SUMMARY OF THE INVENTION

The object underlying the present invention is to provide an axle system which is designed to be easily mountable and dismountable without impairing hereby the operational safety of sensitive attachment units or of the entire axle system.

According to the invention the axle system comprises an external unit, a hub unit and a brake drum element, wherein the external unit has a maximum extent D₁ transversely with respect to an axis of rotation, wherein the brake drum element comprises a face part, which extends transversely with respect to the axis of rotation and comprises a cutout, and which comprises a drum casing, which extends essentially parallel to the axis of rotation, wherein the cutout of the face part has an extent transversely with respect to the axis of rotation of at least D₁, wherein the extent of the drum casing transversely with respect to the axis of rotation is smaller than the internal dimension D₂ of an attachment unit which can be fixed to the brake drum element and at least partially surrounds the same, wherein the external unit in the direction of the axis of rotation is arranged on the hub unit, and wherein the brake drum element can be moved over the external unit and fixed to the hub unit. Said axis of rotation here is preferably the axle of the vehicle on which the axle system or a wheel suspension system for wheels on commercial vehicles, respectively, is arranged. At the outer end of said axle there is arranged an external unit, wherein the external unit has a maximum extent D₁ transversely, or preferably perpendicularly, with respect to the axis of rotation. Preferably, the external unit has a circular cross-section, wherein D₁ in this embodiments is the outer diameter of the external unit. In further preferred embodiments the external unit has an elliptical, rectangular or polygonal cross-section, wherein D₁ in each of these cases is the maximum extent transversely, or preferably perpendicularly, to the axis of rotation of said cross-sections. According to the invention the brake drum element comprises a face part and a drum casing, wherein the face part extends essentially transversely and the drum casing extends essentially parallel with respect to the axis of rotation. Preferably, the face part extends perpendicularly to the axis of rotation. The face part comprises a cutout and, thus, in a preferred embodiment, has the shape of a ring plate. In further preferred embodiments the face part may also have a conical shape or comprise landings or shoulders or steps along the axis of rotation. According to the invention on the face part of the brake drum element there is provided a cutout, wherein the cutout has an extent transversely with respect to the axis of rotation, which is at least as large or larger than the maximum extent D₁ of the external unit transversely with respect to the axis of rotation. The cross-section of the cutout preferably is adapted to the cross-section of the external unit or congruent hereto, i.e. in the case of an external unit with a circular cross-section, the cutout is preferably circular, too.

Preferably, the cutout has a slightly larger extent than the external unit so that between the cutout and the external unit there is formed a gap which in turn simplifies the mounting and dismounting of the brake drum element. The gap between the cutout and the external unit preferably has a width of at least 0.5 mm to 10 cm. In this way, it may be easily avoided that the brake drum element hits or jams at the external unit in the area of the cutout when the brake drum element is mounted or dismounted. The gap may also be at least 1 mm, preferably 2 mm to 10 mm. Apart from the face part, the brake drum element comprises a drum casing which extends essentially parallel to the axis of rotation. Essentially parallel means that the drum casing may indeed have a conical or convex-concave cross-sectional geometry, however the change in distance to the axis of rotation in the course of the cross-section is preferably small compared to the extent of the drum casing along the axis of rotation. Preferably, the drum casing has the shape of a hollow cylinder. The drum casing and the face part are preferably joined to form a single piece, and for the overall shape of the brake drum element there results a hollow body with a cap, wherein the cap or the face part itself comprises a cutout. The maximum extent of the drum casing and of the face part transversely with respect to the axis of rotation is limited by an attachment unit which can be attached to the axle system. Said attachment unit preferably comprises a portion having an inwards-facing surface, wherein said surface has an extent of D₂ transversely with respect to the axis of rotation. The brake drum element should be designed so that it can be inserted or slid into the attachment unit at least partially, in particular into the area of the inwards-facing surface of the attachment unit, so that the maximum extent of the brake drum element transversely with respect to the axis of rotation is limited towards the outside by the internal dimension D₂ of the attachment unit surrounding the brake drum element. Thus, there are two limiting dimensions for the brake drum element: D₁ as the external dimension of the external unit, which may not be undershot by the cutout in the face part of the brake drum element, and the minimum extent D₂ transversely with respect to the axis of rotation of the inwards-facing surface of the attachment unit, which may not be exceeded by the external dimension of the brake drum element. In this way, it is achieved that the brake drum element is movable over the external unit, which means that the brake drum element is movable over the external unit, which is preferably firmly fastened to the hub and which may subsequently be fixed to the hub. According to the invention the brake drum element may thus be mounted and dismounted without dismounting the compound of hub unit and external unit. In practice this means that the brake drums and for example the brake shoe elements may be exchanged, maintained and mounted again within said brake drum without dismounting the other parts attached to the axle system.

In a preferred embodiment the brake drum element may be mounted and dismounted while the external unit remains fixed to the hub unit. This preferred feature of the axle system ensures that the connection between the hub unit and the external unit does not have to be released and that it is thus avoided that for example dirt and other foreign matter gets into the external unit, which is sensitive under certain circumstances.

In a particularly preferred embodiment the drum casing is designed multi-part and comprises a friction element and a carrier portion. The carrier portion is provided preferably at the outside of the drum casing, and the friction element is attached to its inner surface. In a further preferred embodiment the carrier portion is designed to form a single piece with the face part of the brake drum element. Like the drum casing also the carrier portion preferably has the shape of a hollow cylinder, wherein at its interior surface the friction element is firmly connected to the carrier portion preferably by means of a material connection or substance-to-substance connection. At its outer surface the carrier portion preferably comprises reinforcements into which recesses are inserted which are suitable for accommodating fastening elements in order to be able to add further attachment parts to the axle system. By providing local reinforcements at the carrier portion it is possible to increase both the strength of the brake drum element, wherein at the same time the weight, compared to a complete reinforcement of the entire carrier portion, has to be increased only slightly.

In a preferred embodiment the carrier portion is made from a material of higher strength than the friction element. Preferably, in the carrier portion, the material has a high tensile strength so that with a constant cross-sectional thickness higher forces may be absorbed, which in turn lead to higher stresses (bending stress, tensile stress) in the material. The manufacturing material of the friction element preferably is a good friction partner for common brake linings for brake shoes used in drum brakes. Preferably, the friction element is connected to the carrier portion by means of a positive locking and/or material connection, wherein it is ensured that the high braking forces may be transmitted from the friction element to the carrier portion via said connection. The preferred manufacturing material for the carrier portion is spherulithic graphite iron, also referred to as nodular cast iron, which has a particularly high tensile strength and is thus suitable to transmit the high forces which occur when the material thickness is comparably small. The friction element is preferably made from gray cast iron since gray cast iron is a particularly suitable friction partner for common brake lining materials. In this way it is possible to combine the good frictional properties of gray cast iron with the high tensile strength of spherulithic graphite cast iron and to thus further reduce the required material thickness. In this way it is preferably possible to advantageously reduce the installation space required by the brake drum element. Particularly advantageously it is thus possible to keep that portion in which the brake drum element is fixed to the hub unit particularly small since the stabler material withstands the momenta and forces which occur also in the case of low material strength. In this way it is possible to use an especially flat hub, which in turn is beneficial for the basic idea of the axle system according to the invention since in this way the required outer diameter of the brake drum element may be reduced and the possible outer diameter or the maximum extent D₁ transversely with respect to the axis of rotation of the external unit, respectively, may be increased. Preferably, the friction element may be inserted into the carrier portion or the brake drum element, respectively, by means of a centrifugal casting process.

In a preferred embodiment the relationship of the extent of the cutout to the maximum extent of the brake drum element transversely with respect to the axis of rotation is larger than 0.4, preferably larger than 0.6, and particularly preferably about 0.7 to 0.85. It has been found that by means of said relationships the installation space between the two limiting values D₂ outside and D₁ inside, in the case of material combinations of various cast irons, may be utilized particularly well. The lower limit of 0.4 of said relationship is particularly preferred if a small external unit is to be combined with a relatively large fastening area between the brake drum and the hub. The preferred relationship of 0.85 of the extent of the cutout to the maximum extent of the brake drum element transversely with respect to the axis of rotation is particularly advantageous if a large external unit is to be combined with a relatively small brake drum element on the axle system. Said relationship of 0.85 goes along with a small portion which serves for fastening the brake drum element on the hub unit, and consequently with a great demand on the strength of the material of the brake drum element.

In an advantageous embodiment the axle system comprises a wheel unit, wherein the wheel unit comprises a rim casing which extends essentially parallel to the axis of rotation, wherein the inner surface of the rim casing facing towards the axis of rotation has a minimum extent D₂ transversely, or preferably perpendicularly, to the axis of rotation, and wherein the rim casing may be moved over the drum element, and the wheel unit may be fixed to the brake drum element. A preferred object of the axle system thus is to support a wheel unit such that it is rotatable about an axis. Preferably, said wheel unit comprises a rim casing which extends essentially parallel to the axis of rotation. To put it differently, the rim casing is a kind of shell or sleeve, and essentially parallel means in this case that its extent longitudinally with respect to the axis of rotation is larger than the change in distance transversely with respect to the axis of rotation. Preferably, the wheel unit may also have a convex-concave shape. Towards the inside, towards the axis of rotation, the rim casing has a minimum extent D₂, which when dimensioning the axle system represents the outer limit D₂ for the brake drum element. If the outer diameter of the brake drum element is smaller than the minimum extent of the rim casing, the latter may be moved at least partially over the brake drum element.

This is desirable since in this way the track width and the installation space as a whole, which is required by the axle construction, may be reduced since the wheel unit is not arranged in front of the brake drum element, but is partially moved over the same. In further preferred embodiments it is also possible to provide a number of wheel units on the axle system.

In a preferred embodiment the wheel unit is secured to the brake drum element against displacement and torsion relative to the brake drum element by means of a first fastening element. By means of this securing means also momenta such as torsional moments may be transmitted from the brake drum element to the wheel unit or from the wheel unit to the brake drum element, respectively. In a preferred embodiment a plurality of fastening elements are provided between the brake drum element and the wheel unit. It has proved to be advantageous that at least 8, preferably 10 to 15, and particularly preferably 16 first fastening elements fix the wheel unit on the brake drum element. If higher strength is expected from the axle system or required due to safety-related demands, it is possible to use further fastening elements. The number of the fastening elements is limited only by the available installation space on the brake drum element. In a particularly preferred embodiment the fastening element is a screw or bolt. Said screw engages the fastening section of the brake drum element in a positive locking or non-positive locking manner, respectively, and fastens the wheel unit to the brake drum element with the help of a screw head which is thickened compared to the rest of the screw body. In a further preferred embodiment the first fastening means is a wheel bolt which is cast into the brake drum element and which, in its portion encased by the material of the brake drum element, comprises suitable projections which enter into a positive-lock connection with the material of the brake drum element and secure the wheel bolt in this way against displacement and torsion relative to the brake drum element. In this embodiment the wheel unit is fixed to the brake drum element by means of wheel nuts screwed onto the wheel bolt.

In a further preferred embodiment the brake drum element is secured against displacement and torsion relative to the hub unit by means of a second fastening element on the hub unit. By means of the connection made by the second fastening elements between the hub unit and the brake drum element it is possible to transmit momenta, which are transmitted from the external unit to the hub unit, to the brake drum element and to the wheel unit fixed thereto. Preferably, the second fastening elements are arranged closer to the axis of rotation than the first fastening elements, wherein this makes it possible to use a hub unit with a relatively small extent transversely with respect to the axis of rotation. In a preferred embodiment there are arranged at least 6, preferably 10, and particularly preferably 12 to 16 second fastening elements between the hub unit and the brake drum element. The second fastening elements engage respective cutouts provided on the hub unit and exert a tensile force onto the brake drum element, by means of which force the latter is pressed against the hub unit. Particularly preferably, the second fastening elements are Allen screws. The advantage of said screws is that they may be inserted in respective cutouts provided on the brake drum element and may be tightened or released in their recessed state. The screw heads thus do not represent a surface unevenness on the front end of the brake drum element.

In a preferred embodiment the hub unit and/or the drum element and/or the wheel unit are designed essentially rotation-symmetric. Essentially rotation-symmetric means that the cross-sections of the hub unit and/or of the drum unit and/or of the wheel unit preferably do not change during the rotation of the sectional plane about the axis of rotation, or that they change only in their non-supporting portions. Here, at the rotation-symmetric supporting parts of the hub unit and/or of the drum unit and/or of the wheel unit, elements may be fastened or attached which are not designed rotation-symmetric to the axis of rotation.

In a particularly preferred embodiment the external unit is an additional drive unit which is designed to transmit a driving torque onto the hub unit. Preferably, the external unit is connected both to the axle and to the hub and establishes a torque between said two assemblies.

Advantageously, the external unit is fastened by means of suitable fastening elements to the hub unit, the latter to the brake drum element and the brake drum element in turn to the wheel unit, and there is a transmission of force and momentum from the external unit up to the wheel unit. The problem to the solved by the axle system is that a stronger additional drive unit usually has a larger outer diameter D₁, whereby the relationship of the extent of the cutout to the maximum extent of the brake drum element transversely with respect to the axis of rotation has to be increased and the greater forces and momenta to be transmitted by the stronger additional drive unit have to be dealt with or absorbed in a smaller fastening portion between the hub unit and the brake drum element. The material requirements on the fastening portion between the hub unit and the brake drum element and between the wheel unit and the brake drum element are dealt with preferably by manufacturing materials exhibiting sufficiently high strength. Advantageously, as an external unit a hydrostatic additional drive unit may be used, which advantageously transforms a fluid or hydrostatic pressure provided by a hydraulic system into a torque in order to establish the same between the hub unit and the axle, for example. In a further preferred embodiment the external unit is an electrically operated additional drive unit, which particularly preferably may not only transmit a momentum onto the axle system but also may absorb a momentum during a braking operation, for example. Here, the efficiency of a commercial vehicle may be increased by transforming the energy absorbed during a braking operation by the electrical additional drive unit into electrical energy and by accordingly storing electrical energy.

In a preferred embodiment the axle system comprises an engagement means which is designed to engage respective recesses provided on the hub unit and on the brake drum element and to thus secure the hub unit and the brake drum element against torsion relative to each other. The engagement means thus supports the transmission of momentum from the hub unit to the brake drum element and thus from the external unit, or from the additional drive unit, respectively, up to the wheel unit via the various fastening elements. In this way, it is preferably possible to save the threads of the fastening elements from excessive contact pressure and wear resulting therefrom and to thus increase the service live of the axle system. Preferably, the engagement means is a sliding block which engages grooves provided on the hub unit and on the brake drum element. In a particularly preferred embodiment there are arranged 2, 3 or 4 sliding blocks between the hub unit and brake drum element.

Preferably, the axle system is manufactured according to the following steps: providing a hub unit, a brake drum element and a second fastening element, wherein on the hub unit there is arranged an external unit having a maximum extent D₁ transversely with respect to an axis of rotation, wherein the brake drum element comprises a face part, and wherein the face part comprises a cutout with an extent transversely with respect to the axis of rotation of at least D₁, wherein the brake drum element comprises a face part. Then displacing the brake drum element over the hub unit until the face part rests against the hub unit and fixing the brake drum element on the hub unit by means of one or a plurality of second fastening elements.

Particularly preferably, the extent of the cutout of the face part transversely with respect to the axis of rotation has an excess relative to the maximum extent D₁ of the external unit transversely with respect to the axis of rotation of at least 1 mm to 20 cm, preferably 2 mm to 10 cm, and particularly preferably of 10 mm to 2 cm. Said excess of the cutout in the face part of the brake drum element relative to the maximum extension or extent of the external unit in particular serves the purpose of facilitating the mounting of the axle system. Since axle components of a commercial vehicle such as brake drum element or external unit occasionally can be handled by a technician only with great difficulty and efforts, it is important to reduce jamming of said components with each other during the assembly process. Said excess or the gap between the brake drum element and the external unit, respectively, prevents such jamming. Since on each one of the opposite sides of the external unit there is formed a respective gap to the cutout of the brake drum element, the sum of two opposite gap widths is the same as the excess described above. Preferably, each gap width of two opposite gaps amounts to half of said excess. Preferably, however, the gap is chosen not too large since otherwise the area of the face part available for fastening the brake drum element on the hub unit will be reduced too much in the case of a certain size of the external unit.

As a matter of course, the further advantages and features of the axle system according to the invention may also be applied in the method according to the invention for manufacturing an axle system.

Further advantages and features result from the following exemplary description of a preferred embodiment of the axle system according to the invention with reference to the appended Figures. Different features of the various embodiments may be combined within the framework of the invention.

### BRIEF DESCRIPTION OF THE DRAWINGS

FIG. 1 shows a sectional view of a preferred embodiment of the axle system according to the invention,

FIG. 2 shows a sectional view of a preferred embodiment of the brake drum element, and

FIG. 3 shows a view of a preferred embodiment of the brake drum element according to the invention following the direction of the axis of rotation.

### BRIEF DESCRIPTION OF THE PREFERRED EMBODIMENTS

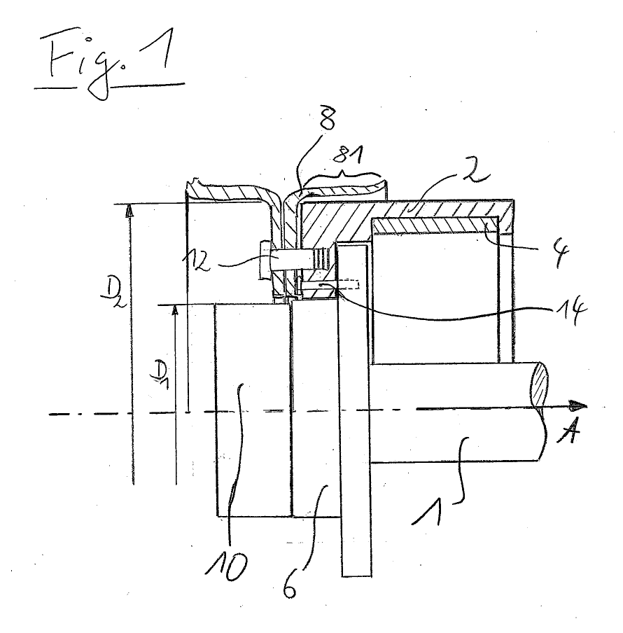

FIG. 1 shows a first preferred embodiment of the axle system according to the invention. A brake drum element 2 is fastened to a hub element 6 preferably by means of a second fastening element 14. The second fastening element 14 is preferably a screw or bolt, wherein the preferred embodiment of the screw shown in the Figure comprises a screw head, which protrudes from the surface of the brake drum element 2, which is on the left-hand side of the Figure. Particularly preferably, a screw having a screw head with an internal hexagon (Allen screw) is used since such screw head may be recessed into the brake drum element and be tightened and released again in its recessed state. At the left-hand side of the hub unit 6 in the Figure there is arranged an external unit 10 on the hub unit 6. The hub unit 6 and the external unit 10 are shown in a non-sectional view, and the fastening elements, by means of which the external unit 10 is fixed to the hub unit 6, are not explicitly shown. The external unit 10 comprises a maximum extent D₁ transversely with respect to the axis of rotation A. Preferably, the external unit 10 is a cylindrically designed hydraulic additional drive unit or an electrical additional drive unit or an electric motor, which applies a torque between an axle 1 and the hub unit 6. As a rule, the axle 1 is rigid or non-rotatable, and the hub unit preferably is supported rotatably on the axle 1 via a supporting arrangement. Furthermore, on the brake drum element 2 there are arranged two wheel units 8 and attached by means of a first fastening element 12. Apart from this preferred embodiment it is also possible to provide only one of the two wheel units 8. The wheel unit 8 preferably comprises a rim casing 81 which extends essentially parallel to the axis of rotation A, wherein the change in distance between the rim casing 81 and the axis of rotation A in the course of the extent parallel to the axis of rotation compared to the amount of the extent of the rim casing parallel to the axis of rotation is to be small, preferably in the range of 0.01 to 0.9. The inner surface of the rim casing 81 facing towards the axis of rotation A has an extent transversely with respect to the axis of rotation A of at least D₂. Since the brake drum element 2 according to the invention has an extent which is smaller than D₂, it is possible to move or slide the wheel unit 8 preferably over the brake drum element 2 until the portion of the wheel unit 8 directed transversely with respect to the axis of rotation A borders on the brake drum element 2. Here, the rim casing 81 preferably is a kind of shell or sleeve which at least partially encloses the brake drum element 2. At the inwards-facing surface of the brake drum element 2 there is preferably provided a friction element 4, wherein the friction element particularly preferably is made from a material which makes a good friction pairing with common brake lining materials. In an advantageous embodiment the hub unit 6, the brake drum element 2, a rotatable part of the external unit 10, the wheel unit 8 and the first and second fastening elements (12, 14) are supported rotatably about the axis of rotation A.

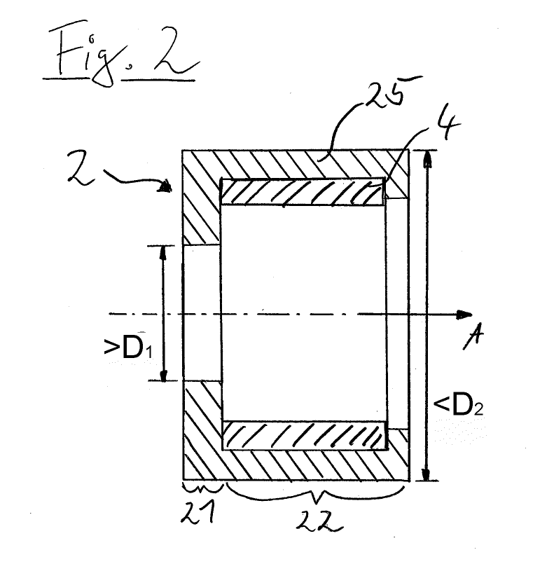

FIG. 2 shows a sectional view of a preferred embodiment of the brake drum element 2 according to the invention. The brake drum element 2 in this preferred embodiment is divided into the two portions face part 21 and drum casing 22. The face part 21 preferably extends transversely with respect to the axis of rotation A, wherein in further embodiments, which are not shown, there may also be preferred a conical, hemispherical or pyramidal geometry of the face part 21. Furthermore, the face part preferably may also have platforms or shoulders parallel to the axis of rotation A. According to the invention, in the face part 21 there is included a cutout, wherein the cutout is directed preferably concentric to the outer surface of the face part 21 and preferably also of the drum casing 22. The minimum extent of the cutout transversely with respect to the axis of rotation A is predefined when the axle system is dimensioned, preferably by the extent D₁ of the external unit 10. In a particularly advantageous embodiment the face part 21 and the cutout are circular or have a cylindrical geometry, respectively. The drum casing 22 extends preferably essentially parallel to the axis of rotation A, wherein its geometry is also preferably conical or has steps transversely with respect to the axis of rotation A. The drum casing 22 preferably comprises a carrier portion 25 and a friction element 4 arranged at its interior. Here, the friction element consists preferably of a material which when paired with common brake lining materials exhibits high coefficients of friction. Particularly preferably, the manufacturing material of the friction element 4 is gray cast iron. Furthermore, it is also possible to use ceramic materials, sintered metals and/or combinations of compound materials for manufacturing the friction element 4. The carrier portion 25 preferably is made from a material of higher strength than the friction element 4. Particularly preferably, the manufacturing material for the carrier portion 25 is nodular graphite cast iron, which is also referred to as spheroidal graphite cast iron, since it has excellent strength properties. Preferably, also the face part 21 is made from nodular graphite cast iron. Preferably, the material thickness at the face part 21 and the carrier portion 25 of the drum casing 22 may be thus reduced, wherein the constantly high forces may now be transmitted by means of greater stresses within the material. Said reduction of the material thickness preferably leads to a decrease in the installation space needed by the entire brake drum element 2 so that the two geometric boundary conditions D₁ and D₂ can be observed. Preferably, the carrier portion 25 and the friction element 4 have a flat geometry in the shape of a hollow cylinder.

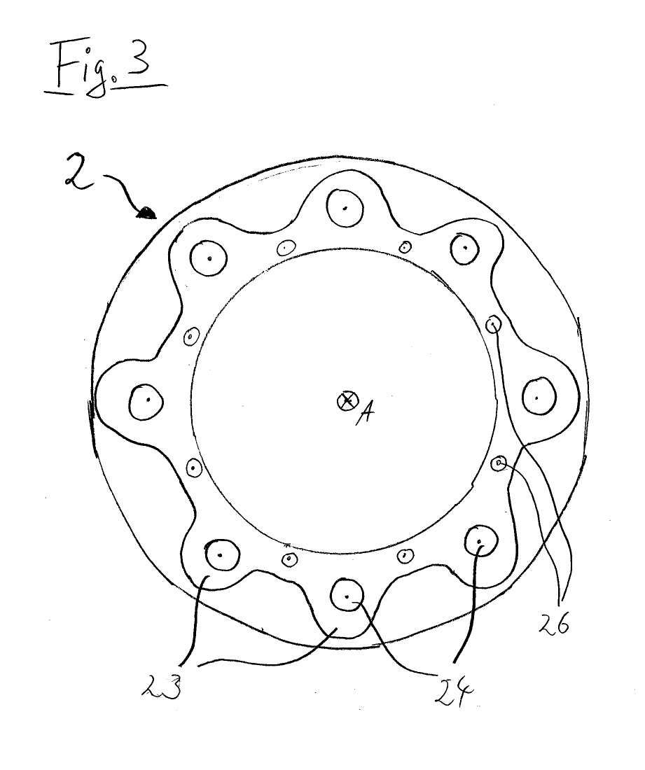

FIG. 3 shows a view along the direction of the axis of rotation A of a preferred embodiment of the brake drum element 2. Preferably, the brake drum element 2 at its outer side comprises reinforcement portions 23. Preferably, said reinforcement portions 23 are characterized by a material accumulation, wherein in each reinforcement portion 23 there is provided a first fastening element accommodation 24. Preferably, a first fastening element 12 engages the first fastening element accommodation 24 and fastens the wheel unit 8 on the brake drum element 2. The material accumulation of the reinforcement portions 23 here preferably makes it possible to favorably distribute the stresses when force is transmitted from the wheel unit 8 to the brake drum element 2 via the first fastening element 12 and the first fastening element accommodation 24. Preferably, the reinforcement portions 23 have rounded geometry courses in order to avoid notch effects when force is transmitted. Preferably, in this preferred embodiment, displaced relative to the first fastening element accommodations, there are arranged second fastening element accommodations 26, in each of which a second fastening element 14 is arranged, engages the hub unit 6 and thus fastens the brake drum element 2 on the hub unit 6. The first fastening element accommodation 24 preferably is designed as a threaded hole, the second fastening element accommodation 26 as a through hole. Here, the second fastening element accommodation 26 preferably comprises a recess of a larger diameter than the through hole, in which preferably a screw head may be recessed. In the Figure there is shown the preferred embodiment with eight first and second fastening element accommodations 24, 26, respectively. In further preferred embodiments there may be provided 10 to 12 and particularly preferably 13 to 18 first and/or second fastening element accommodations 24, 26. Advantageously, there are provided as many fastening element accommodations 24, 26 as there are respective fastening elements 12, 14.

1-11. (canceled)

12. An axle system comprising:
an external unit;
a hub unit; and,
a brake drum element;
wherein the external unit has a maximum extent D₁ transversely with respect to an axis of rotation;
wherein the brake drum element comprises a face part, which extends transversely with respect to the axis of rotation, and comprises a cutout, and a drum casing which extends essentially parallel to the axis of rotation;
wherein the drum casing is multi-part and comprises a friction element and a carrier portion;
wherein the carrier portion comprises a material of higher strength than the friction element;
wherein the cutout of the face part has an extent transversely with respect to the axis of rotation of at least the maximum extent D₁;
wherein an extent of the drum casing transversely with respect to the axis of rotation is smaller than the internal dimension of an attachment unit fixed to and at least partially surrounding the brake drum element;
wherein the external unit is arranged in the direction of the axis of rotation on the hub unit; and,
wherein the brake drum element can be moved over the external unit and fixed to the hub unit.

13. The axle system of claim 12, wherein the brake drum element is mountable and dismountable to the hub unit while the external unit remains fixed to the hub unit.

14. The axle system of claim 13, wherein the relationship of the extent of the cutout to the maximum extent of the brake drum element transversely with respect to the axis of rotation is larger than 0.4.

15. The axle system of claim 14, wherein the relationship of the extent of the cutout to the maximum extent of the brake drum element transversely with respect to the axis of rotation is larger than 0.6.

16. The axle system of claim 15, wherein the relationship of the extent of the cutout to the maximum extent of the brake drum element transversely with respect to the axis of rotation is between about 0.7 and about 0.85.

17. The axle system of claim 14, wherein the attachment unit comprises a wheel unit, the wheel unit comprises a rim casing that extends essentially parallel to the axis of rotation, an inner surface of the rim casing facing the axis of rotation has a minimum extent transversely with respect to the axis of rotation, and wherein the rim casing can be moved over the brake drum element, and the wheel unit can be fixed to the brake drum element.

18. The axle system of claim 17, wherein the wheel unit is secured by a first fastening element at the brake drum element against displacement and torsion relative to the brake drum element.

19. The axle system of claim 18, wherein the brake drum element is secured by a second fastening element at the hub unit against displacement and torsion relative to the hub unit.

20. The axle system of claim 19, wherein at least one of the hub unit, the brake drum element, and the wheel unit are substantially rotation-symmetric.

21. The axle system of claim 20, wherein the external unit comprises an additional drive unit which is designed to transmit at least one of a driving torque and comprises driving momentum onto the hub unit.

22. The axle system of claim 21, further comprising:
an engagement element adapted to engage recesses provided on the hub unit and on the brake drum element, thereby securing the hub unit and the brake drum element against torsion relative to each other.

23. The axle system of claim 22, wherein the extent of the cutout of the face part transversely with respect to the axis of rotation has an excess relative to the maximum extent of the external unit transversely with respect to the axis of rotation of at least 1 mm to 20 cm.

24. The axle system of claim 23, wherein the extent of the cutout of the face part transversely with respect to the axis of rotation has an excess relative to the maximum extent of the external unit transversely with respect to the axis of rotation of between about 2 mm and about 10 cm.

25. The axle system of claim 24, wherein the extent of the cutout of the face part transversely with respect to the axis of rotation has an excess relative to the maximum extent of the external unit transversely with respect to the axis of rotation of between about 10 mm and about 2 cm.

26. The axle system of claim 12, wherein the relationship of the extent of the cutout to the maximum extent of the brake drum element transversely with respect to the axis of rotation is larger than 0.4.

27. The axle system of claim 26, wherein the relationship of the extent of the cutout to the maximum extent of the brake drum element transversely with respect to the axis of rotation is larger than 0.6.

28. The axle system of claim 27, wherein the relationship of the extent of the cutout to the maximum extent of the brake drum element transversely with respect to the axis of rotation is between about 0.7 and about 0.85.

29. The axle system of claim 12, wherein the attachment unit comprises a wheel unit, the wheel unit comprises a rim casing that extends essentially parallel to the axis of rotation, an inner surface of the rim casing facing the axis of rotation has a minimum extent transversely with respect to the axis of rotation, and wherein the rim casing can be moved over the brake drum element, and the wheel unit can be fixed to the brake drum element.

30. The axle system of claim 29, wherein the wheel unit is secured by a first fastening element at the brake drum element against displacement and torsion relative to the brake drum element.

31. The axle system of claim 12, wherein the brake drum element is secured by a second fastening element at the hub unit against displacement and torsion relative to the hub unit.

32. The axle system of claim 12, wherein at least one of the hub unit, the brake drum element, and the wheel unit are substantially rotation-symmetric.

33. The axle system of claim 12, wherein the external unit comprises an additional drive unit which is designed to transmit at least one of a driving torque and comprises driving momentum onto the hub unit.

34. The axle system of claim 12, further comprising:
an engagement element adapted to engage recesses provided on the hub unit and on the brake drum element, thereby securing the hub unit and the brake drum element against torsion relative to each other.

35. The axle system of claim 12, wherein the extent of the cutout of the face part transversely with respect to the axis of rotation has an excess relative to the maximum extent of the external unit transversely with respect to the axis of rotation of at least 1 mm to 20 cm.

36. The axle system of claim 35, wherein the extent of the cutout of the face part transversely with respect to the axis of rotation has an excess relative to the maximum extent of the external unit transversely with respect to the axis of rotation of between about 2 mm and about 10 cm.

37. The axle system of claim 36, wherein the extent of the cutout of the face part transversely with respect to the axis of rotation has an excess relative to the maximum extent of the external unit transversely with respect to the axis of rotation of between about 10 mm and about 2 cm.

38. A method of manufacturing an axle system, comprising the steps of:
providing a hub unit;
providing a brake drum element;
providing at least a second fastening element;
wherein on the hub unit there is arranged an external unit with a maximum extent D₁ transversely with respect to an axis of rotation;
wherein the brake drum element comprises a face part and a drum casing that extends essentially parallel to the axis of rotation;
wherein the face part comprises a cutout with an extent transversely with respect to the axis of rotation of at least the maximum extent D₁;
wherein the drum casing is designed multi-part and comprises a friction element and a carrier portion; and,
wherein the carrier portion comprises a material of higher strength than the friction element;
displacing the brake drum element along the axis of rotation over the hub unit until the face part rests against the hub unit; and
fixing the brake drum element to the hub unit by at least one second fastening element.
